(19) United States
(12) Patent Application Publication
(10) Pub. No.: US 2023/0039211 A1
(43) Pub. Date: Feb. 9, 2023

(54) SUPPORT FOR HOLDING DIVERSE ARTICLES WITHIN FACILE REACH FOR OCCUPANTS IN A MOTOR VEHICLE HAVING A CUP HOLDER

(71) Applicant: David C. Edwards, Virginia Beach, VA (US)

(72) Inventor: David C. Edwards, Virginia Beach, VA (US)

(21) Appl. No.: 17/396,075

(22) Filed: Aug. 6, 2021

(51) Int. Cl. B60R 11/02; B60N 3/10

(52) U.S. Cl. CPC B60R 11/0241; B60N 3/101; B60R 2011/0007

(57) ABSTRACT

A holder for diverse personal articles anchored within a cup holder of a motor vehicle cabin is shown and described. The holder has a frustoconical base to be inserted into the cup holder, a multi-compartmented receptacle, and a flexible neck or connecting arm spanning the base and receptacle. The flexible neck holds its configuration once bent by hand to locate the receptacle as desired. The receptacle may have detachable pockets and a positionally and orientationally adjustable cellular phone holder.

### RELATED APPLICATIONS

This application claims priority in accordance with 37 CF.R. ¶ 1.19(e) to U.S. Provisional Patent Application Ser. No. 63/151,160 filed for SUPPORT FOR HOLDING DIVERSE ARTICLES WITHIN FACILE REACH FOR OCCUPANTS IN A MOTOR VEHICLE HAVING A CUP HOLDER filed Feb. 19, 2021 which is included herein in its entirety by reference.

### FIELD OF THE INVENTION

This invention relates in general to a support or holder for diverse personal articles, the support or holder insertible into a cup holder of a motor vehicle.

### BACKGROUND OF THE INVENTION

Occupants of motor vehicles typically prefer to keep certain personal articles of convenience within easy reach in the motor vehicle. These articles may include for example eyeglasses, keys, electronic cards such as access cards, credit and debit cards, and organization membership cards, sanitary tissues, writing instruments, cigarettes, and electronic communications devices. Today, most motor vehicles are provided with consoles including cup holders configured to receive and grasp frustoconical drinking cups. Vehicles have various accommodations for personal articles such as a glove box, recesses in door handles, dashboard, and other vehicle cabin surfaces. However, these accommodations are widely distributed throughout the cabin, and may not provide the immediate, convenient access to the personal articles which may be desirable.

### SUMMARY OF THE INVENTION

The present invention provides a convenient support system for holding personal articles at the ready, for the benefit of occupants of a motor vehicle. The support system takes advantage of existing cup holders of motor vehicles, using such cup holders for anchorage by receiving a cooperating base.

The support system includes a multi-compartmented holder including both storage compartments for general purpose use, and a cellular phone holder. The storage compartments are connected to the base by a flexible neck. The neck is manually bendable to position the compartments conveniently but resists spontaneous deformation.

Various advantages of this invention will become apparent to those skilled in the art from the following detailed description of the preferred embodiment, when read in light of the accompanying drawings.

### BRIEF DESCRIPTION OF THE DRAWINGS

Various features and attendant advantages of a reactive mattress and a pendant controller combination will become more fully appreciated when considered in view of the accompanying drawings, in which like reference characters designate the same or similar parts and/or features throughout the several views, and wherein:

FIG. 1 is a front perspective view of an article support, according to at least one aspect of the invention; and

FIG. 2 is an exploded view otherwise similar to FIG. 1.

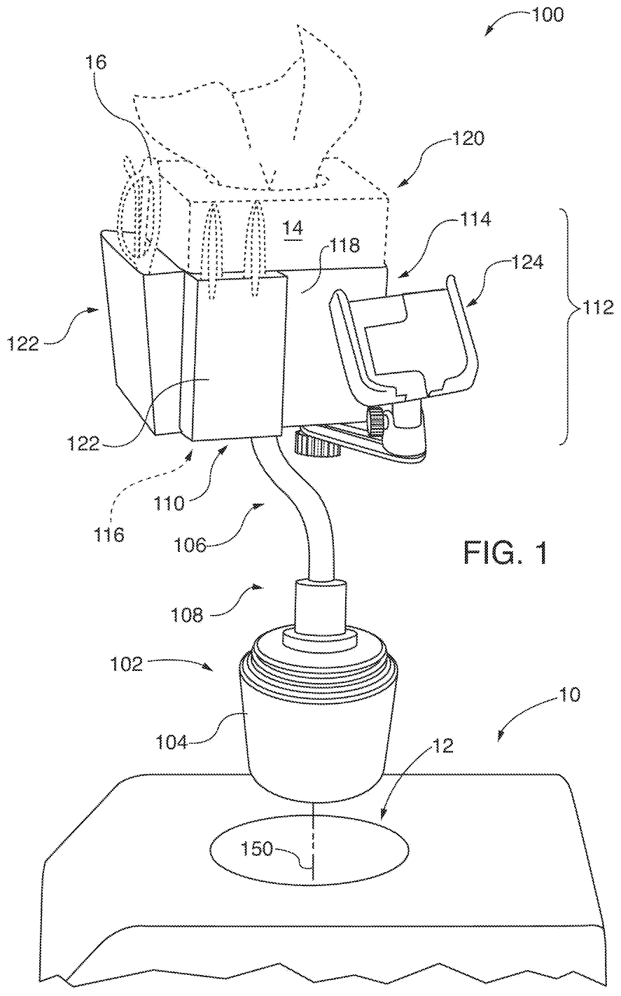

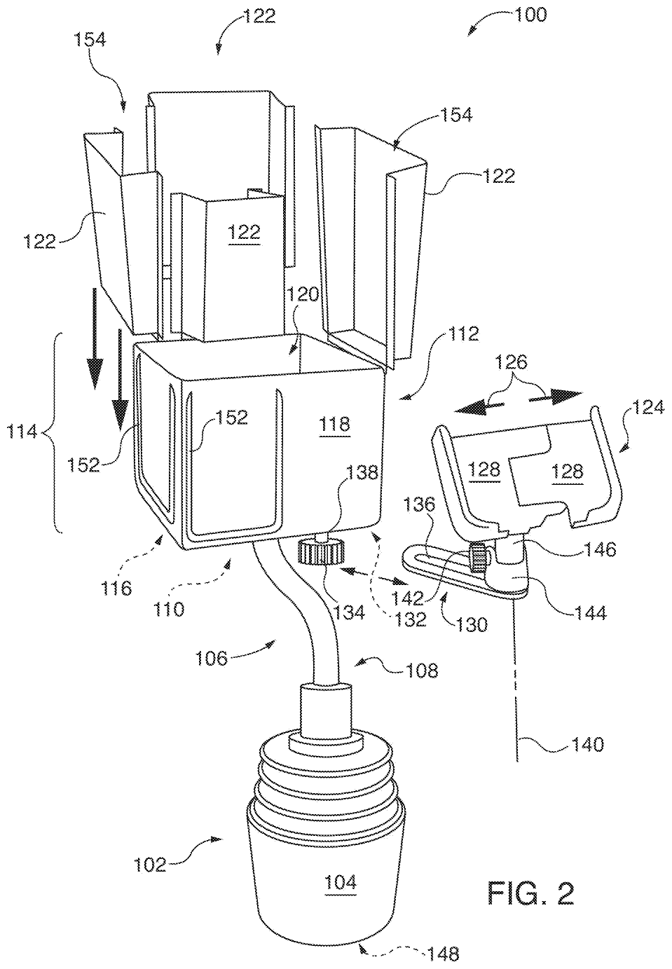

Drawing FIGS. 1 and 2 are drawn to internal scale and external scale. By internal scale it is meant that the parts, components, and proportions thereof in the illustrated inventive example are drawn to scale relative to one another. As employed herein, external scale refers to scale of the illustrated example relative to scale of environmental elements or objects, regardless of whether the latter are included in the drawings. Where the inventive example claims external scale, the inventive and environmental elements may of course not be drawn to real or true life scale; rather, external scale signifies only that both the invention and environmental elements are drawn in scale to each other.

### DETAILED DESCRIPTION OF THE PREFERRED EMBODIMENT

Referring now to the drawings, there is illustrated in FIGS. 1 and 2 a support 100 for holding diverse articles within facile reach for occupants (not shown) in a motor vehicle (not shown) having a cup holder 10 configured to receive frustoconical drinking cups (not shown). Support 100 may comprise a base 102 including a frustoconical lateral surface 104 dimensioned and configured to be received in close fit within a cup holding portion 12 of cup holder 10, a connecting arm 106 coupled at a proximal end 108 to base 102 and terminating at an opposed distal end 110, and a multi-article holder 112 for supporting the diverse articles within reach for the occupants. Multi-article holder 112 is coupled to connecting arm 106 proximate distal end 110 of connecting arm 106. Multi-article holder 112 further comprises a receptacle 114 having a floor 116, a lateral wall 118, and an open upper end 120. Multi-article holder 112 also includes at least one upwardly open pocket 122 coupled to lateral wall 118 of receptacle 114, and a cellular phone holder 124 coupled to receptacle 114. Cellular phone holder 124 is dimensioned and configured to close over and retain a cellular phone (not shown).

It should be noted at this point that orientational terms such as upper and upwardly, above, vertical and vertically, and bottom are used for semantic purposes, e.g., to distinguish one element from a second, similar element or to clarify directions of motion or approach. Moreover, the drawings show their subject matter in ordinary positions of use, thereby arbitrarily establishing verticality. Therefore, orientational terms must be understood to provide semantic basis for purposes of description, do not necessarily apply to their literally construed meanings, and do not limit the invention or its component parts in any particular way.

Connecting arm 106 is flexible, capable of being bent by manual forces, resistant to spontaneous bending in the absence of manual forces, and sufficiently long to enable multi-article holder 112 to be displaced from a position directly above base 102 a predetermined distance of at least three inches to a succeeding position and oriented vertically in the succeeding position. This allows for fine adjustment of location of articles held within support 100 when cup holder 10 is not ideally located for occupants of the vehicle.

Cellular phone holder 124 is configured to adjust in width (indicated by arrows 126 in FIG. 2) to close over cellular phones (not shown) of different widths. Cellular phone holder 124 may be fabricated in two slidably interengaging sections 128 held in place by friction or by detents (not shown) for example. Called out in FIG. 2, cellular phone holder 124 may include a support stem 130 providing positional adjustment, whereby distance of a cellular phone held in cellular phone holder 124 from receptacle 114 may be adjusted. To this end, receptacle 114 may comprise a threaded hole 132 and a screw 134 configured to thread into threaded hole 132. Support stem 130 may comprise an elongated slot 136 extending along a length of support stem 130. Support stem 130 can be clamped to receptacle 114 at a selected distance from receptacle 114 within a predetermined range, by passing a shank 138 of screw 134 through slot 136 and threading shank 138 into threaded hole 132.

Cellular phone holder 124 may be configured to hold the cellular phone in an orientation wherein a principal face of the cellular phone is inclined from a vertical direction. For example, the cellular phone may be tilted to be easily viewed by an occupant of the motor vehicle.

Cellular phone holder 124 may have an adjustment feature operable to vary lateral orientation of cellular phone holder 124 about a vertical axis 140 passing through support stem 130.

In the example of FIG. 2, the adjustment feature may utilize a setscrew 142 threaded into a collar 144 fixed to support stem 130. Setscrew 142 secures shaft 146 of cellular phone holder 124 in a selected angular position about axis 140.

Frustoconical base 102 may have a planar bottom surface 148 perpendicular to a direction of insertion (seen as axis 150 in FIG. 1) of frustoconical base 102 into cupholder 10. This feature enables base 102 to cooperate with most cup holders, the latter being in turn configured to cooperate with conventional drinking cups (not shown) having flat bottoms.

As is clearly shown in FIG. 2, lateral wall 118 of receptacle 114 may comprise at least two vertical slots 152 for each pocket 122. Each pocket 122 may have at least two flanged extensions 154 interfitting within and engageable with vertical slots 152, whereby pockets 122 are manually attachable to and removable from receptacle 114 by maneuvering flanged extensions 154 into associated slots 152. In the example of FIG. 2, slots 152 are U-shaped, so that a portion of lateral wall 118 can be pressed inwardly slightly (relative to an interior of receptacle 114) or outwardly to facilitate insertion of flanged extensions 154 into and out of slots 152.

In the example of FIGS. 1 and 2, the at least one upwardly open pocket 122 comprises four upwardly open pockets 122. Receptacle 114 is rectangular in cross section such that lateral wall 118 has four sections 156, 158, 160, 162 each perpendicular to two other said sections 156, 158, 160, or 162 and parallel to an opposed said section 156, 158, 160, or 162. Each section 156, 158, 160, or 162 has slots 152 for receiving attachment of one of four pockets 122.

As seen in FIG. 1, receptacle 114 may have an interior receptacle volume dimensioned and configured to contain a tissue dispenser 14 of commercially available size. The interior receptacle volume is that volume surrounded by wall sections 156, 158, 160, 162. In the example of FIG. 1, tissue dispenser 14 may be of a size conventionally called personal size.

At least one pocket 122 is dimensioned and configured to receive and retain folded eyeglasses 16.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. A support for holding diverse articles within facile reach for occupants in a motor vehicle having a cup holder configured to receive frustoconical drinking cups, the support comprising:
a base including a frustoconical lateral surface dimensioned and configured to be received in close fit within a cup holding portion of the cup holder;
a connecting arm coupled at a proximal end to the base and terminating at an opposed distal end; and
a multi-article holder for supporting the diverse articles within reach for the occupants, the multi-article holder coupled to the connecting arm proximate the distal end of the connecting arm, the multi-article holder further comprising
a receptacle having a floor, a lateral wall, and an open upper end,
at least one upwardly open pocket coupled to the lateral wall of the receptacle, and
a cellular phone holder coupled to the receptacle, the cellular phone holder dimensioned and configured to close over and retain a cellular phone.

2. The support of claim 1, wherein the connecting arm is flexible, capable of being bent by manual forces, resistant to spontaneous bending in the absence of manual forces, and sufficiently long to enable the multi-article holder to be displaced from a position directly above the base a predetermined distance of at least three inches to a succeeding position and oriented vertically in the succeeding position.

3. The support of claim 1, wherein the cellular phone holder is configured to adjust in width to close over cellular phones of different widths.

4. The support of claim 1, wherein the cellular phone holder includes a support stem providing positional adjustment, whereby distance of a cellular phone held in the cellular phone holder from the receptacle may be adjusted.

5. The support of claim 4 wherein
the receptacle comprises a threaded hole and a screw configured to thread into the threaded hole;
the support stem comprises an elongated slot extending along a length of the support stem, and
the support stem can be clamped to the receptacle at a selected distance from the receptacle within a predetermined range, by passing a shank of the screw through the slot and threading the shank into the threaded hole.

6. The support of claim 1, wherein the cellular phone holder is configured to hold the cellular phone in an orientation wherein a principal face of the cellular phone is inclined from a vertical direction.

7. The support of claim 1, wherein the cellular phone holder has an adjustment feature operable to vary lateral orientation of the cellular phone holder about a vertical axis passing through the support stem.

8. The support of claim 1, wherein the frustoconical base has a planar bottom surface perpendicular to a direction of insertion of the frustoconical base into the cupholder.

9. The support of claim 1, wherein the lateral wall of the receptacle comprises at least two vertical slots for each pocket, and each pocket has at least two flanged extensions interfitting within and engageable with the vertical slots, whereby the Dockets are manually attachable to and removable from the receptacle by maneuvering the flanged extensions into associated slots.

10. The support of claim 1, wherein the at least one upwardly open pocket comprises four upwardly open pockets, the receptacle is rectangular in cross section such that the lateral wall has four sections each perpendicular to two other said sections and parallel to an opposed said section, and each section has slots for receiving attachment of one of four pockets.

11. The support of claim 1, wherein the receptacle has an interior receptacle volume dimensioned and configured to contain a tissue dispenser of commercially available size.

12. The support of claim 1, wherein at least one pocket is dimensioned and configured to receive and retain folded eyeglasses.
